(19) United States
(12) Patent Application Publication
(10) Pub. No.: US 2023/0045894 A1
(43) Pub. Date: Feb. 16, 2023

(54) ASYMMETRIC FLUTED INFEEDS

(71) Applicant: Seattle Food Tech, Inc., Seattle, WA (US)

(72) Inventor: Chloe Grubb, Seattle, WA (US)

(21) Appl. No.: 17/402,468

(22) Filed: Aug. 13, 2021

(51) Int. Cl. B01F 7/00; B01F 3/12; B01F 3/18; B01F 7/24

(52) U.S. Cl. CPC B01F 7/00416; B01F 3/1221; B01F 3/18; B01F 7/241; B01F 2215/0014

(57) ABSTRACT

An apparatus can include an outer housing, a first processing shaft and a second processing shaft. The outer housing can include first, second, and third inlet regions and an outlet. Both processing shafts can be proximate and parallel to each other extending through the outer housing and can be configured to rotate within the outer housing to mix and convey foodstuff materials from the first, second, and third inlet regions to the outlet. The first processing shaft can have a first fluted infeed portion proximate the first inlet region and a first mixing portion extending from the third inlet region to the outlet. The second processing shaft can have a second fluted infeed portion proximate the second inlet region and a second mixing portion extending from the third inlet region to the outlet. At least a portion of the first and second processing shafts can be asymmetric.

### TECHNICAL FIELD

The present disclosure relates generally to food processing, and more particularly to devices and methods that can be used in the formation of plant-based meat analogue products (hereinafter “plant-based meat”).

### BACKGROUND

Plant-based meat products are becoming increasingly popular and plant-based meat production is a rapidly growing industry. One important aspect of plant-based meat production is to process various ingredients or foodstuff materials in different ways. Such foodstuff materials for plant-based meat production can include, for example, soy protein, hydrated vegetable protein, methylcellulose, oil, and water, among other possible foodstuff materials. One typical way of processing plant-based foodstuff materials is to introduce different foodstuff materials into a mixing apparatus or system, such as a bowl chopper, blender, globe mixer, or the like.

Unfortunately, the nature of some foodstuff materials can cause disruptions in many processing arrangements. This often results in discontinuous outputs and can cause reductions in output volume rates due to issues processing typically highly viscous mixed foodstuff materials. This can even result in the occasional need to stop the overall system just to manually load and/or remove foodstuff materials being processed. Overall production volumes can then suffer as a result of such lack of continuity and inconsistent output quality and quantities.

Although traditional ways of processing plant-based food products have worked fine in the past, improvements are always welcome. In particular, what is desired are improved systems and methods for processing foodstuff materials that are continuous and consistent.

### SUMMARY

It is an advantage of the present disclosure to provide improved systems and methods for processing different foodstuff materials, such as plant-based foodstuff materials. The disclosed features, apparatuses, systems, and methods provide improved processing solutions that result in continuous and consistent production, with little to no clumping, bridging, or clogging of the foodstuff materials being processed. These advantages can be accomplished at least in part by using processing shafts having mixing portions and asymmetric fluted infeed portions that are specifically designed to provide rotating gaps in the material path during processing, such as mixing and conveyance.

In various embodiments of the present disclosure, an apparatus configured to process foodstuff materials can include an outer housing, a first processing shaft, and a second processing shaft. The outer housing can have at least first, second, and third inlet regions and an outlet, with the first and second inlet regions being configured to accept one or more solid foodstuff materials and the third inlet region being configured to accept one or more liquid foodstuff materials downstream from the first and second inlet regions. The first processing shaft can extend through the outer housing from the first inlet region to the outlet and can have a first fluted infeed portion proximate the first inlet region and a first mixing portion extending from the third inlet region to the outlet. The first processing shaft can be configured to rotate within the outer housing to convey the solid and liquid foodstuff materials from the first, second, and third inlet regions to the outlet. The second processing shaft can extend through the outer housing from the second inlet region to the outlet and can be situated proximate and parallel to the first processing shaft. The second processing shaft can have a second fluted infeed portion proximate the second inlet region and a second mixing portion extending from the third inlet region to the outlet. The second processing shaft can also be configured to rotate within the outer housing to convey the solid and liquid foodstuff materials from the first, second, and third inlet regions to the outlet and can be configured to operate in conjunction with the first processing shaft to mix the solid and liquid foodstuff materials during conveyance thereof. At least a portion of the first and second processing shafts can be asymmetric with respect to each other.

In various detailed embodiments, the first fluted infeed portion can be asymmetric with respect to the second fluted infeed portion. In one arrangement, the first fluted infeed portion can be single fluted while the second fluted infeed portion can be double fluted. The pitch of the first fluted infeed portion can be the same as the pitch of the second fluted infeed portion, which pitch can be about one revolution per four inches. In some arrangements, the first processing shaft can have at least some portions that are symmetric with respect to at least some portions of the second processing shaft. The first inlet region can be oriented perpendicular to the axes of rotation of the first and second processing shafts. Also, the first and second inlet regions can be configured to deposit the one or more solid foodstuff materials directly onto the flutes of the first fluted infeed portion and the second fluted infeed portion. The third inlet region can be oriented perpendicular to the axes of rotation of the first and second processing shafts. Also, the third inlet region can be configured to deposit the one or more liquid foodstuff materials directly onto the first mixing portion and the second mixing portion. The lengths of the first fluted infeed portion and the second fluted infeed portion can be about four inches each in some arrangements.

In various further embodiments of the present disclosure, a conveyance can include a first processing shaft and a second processing shaft. The first processing shaft can have a first fluted infeed portion and a first mixing portion and can be configured to rotate to convey materials along the first fluted infeed portion and first mixing portion. The second processing shaft can be situated proximate and parallel to the first processing shaft and can have a second fluted infeed portion proximate the first fluted infeed portion and a second mixing portion proximate the second mixing portion. The second processing shaft can be configured to rotate to convey materials along the second fluted infeed portion and second mixing portion and to operate in conjunction with the first processing shaft to mix the materials during conveyance thereof. At least a portion of the first and second processing shafts can be asymmetric with respect to each other.

In various detailed embodiments, the first fluted infeed portion can be asymmetric with respect to the second fluted infeed portion. The first fluted infeed portion can be single fluted and the second fluted infeed portion can be double fluted. The pitch of the first fluted infeed portion can be the same as the pitch of the second fluted infeed portion and can be about one revolution per four inches, for example. The first mixing portion can be symmetric with respect to the second mixing portion in some arrangements.

In still further embodiments of the present disclosure, various methods of mixing foodstuff materials are provided. Pertinent process steps can include providing a first foodstuff material into a first inlet region of a foodstuff material processing device having first and second processing shafts, inputting a second foodstuff material into a second inlet region of the foodstuff material processing device, introducing a third foodstuff material into a third inlet region of the foodstuff material processing device, rotating the first and second processing shafts to mix and convey the first, second, and third foodstuff materials from the first, second, and third inlet regions to an outlet of the foodstuff material processing device, and collecting a resulting mixed foodstuff material at the outlet. The first and second inlet regions can be at the same opening in the foodstuff material processing device. The third inlet region can be located downstream from the first and second inlet regions. The first processing shaft can have a first fluted infeed portion and a first mixing portion. The second processing shaft can be situated proximate and parallel to the first processing shaft and can have a second fluted infeed portion proximate the first fluted infeed portion and a second mixing portion proximate the first mixing portion. At least a portion of the first and second fluted infeed portions can be asymmetric with respect to each other. In various arrangements, the first processing shaft can be configured to rotate to convey the first, second, and third foodstuff materials along its first fluted infeed portion and first mixing portion, and the second processing shaft can be configured to rotate to convey the first, second, and third foodstuff materials along its second fluted infeed portion and second mixing portion, and can also be configured to operate in conjunction with the first processing shaft to mix the first, second, and third foodstuff materials during conveyance thereof. The first and second foodstuff materials can be solid, while the third foodstuff material can be liquid.

Other apparatuses, methods, features, and advantages of the disclosure will be or will become apparent to one with skill in the art upon examination of the following figures and detailed description. It is intended that all such additional apparatuses, methods, features, and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems and methods for processing foodstuff materials using asymmetric fluted infeeds. These drawings in no way limit any changes in form and detail that may be made to the disclosure by one skilled in the art without departing from the spirit and scope of the disclosure.

FIG. 1 illustrates a block diagram of an example foodstuff material processing device according to one embodiment of the present disclosure.

FIG. 2 illustrates in top plan view an upstream portion of an example foodstuff material processing device having processing shafts with at least a portion thereof being asymmetric according to one embodiment of the present disclosure.

FIG. 3 illustrates in top plan view the foodstuff material processing device of FIG. 2 with its outer housing removed according to one embodiment of the present disclosure.

FIGS. 4A-4D illustrate in side perspective view asymmetric fluted infeed portions at various stages of rotation according to one embodiment of the present disclosure.

FIGS. 5A-5D illustrate in top plan view the asymmetric fluted infeed portions of FIGS. 4A-4D at various stages of rotation according to one embodiment of the present disclosure.

FIG. 6 illustrates a flowchart of an example method of processing foodstuffs using processing shafts with at least a portion thereof being asymmetric according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, that other embodiments may be used, and that changes may be made without departing from the spirit and scope of the disclosure.

The present disclosure relates in various embodiments to features, apparatuses, systems, and methods for processing materials. The disclosed embodiments can be specifically used for processing foodstuff materials, such as conveying and mixing the foodstuff materials, for example, such as in the production of plant-based meat products. In particular, the disclosed embodiments can utilize a foodstuff material processing device having processing shafts with at least a portion thereof being asymmetric to convey and mix different foodstuff materials in a manner that is continuous and consistent with little to no clumping, bridging, or clogging of the foodstuff materials being processed.

Other fluted conveyances have been symmetrical in nature, such that there is a constant gap or distance between the mating flutes during rotational operation of the fluted conveyances. This tends to result in clumping, bridging, and/or clogging of the materials being mixed and conveyed during continuous rotational use. Unlike other fluted conveyances, the disclosed processing shafts having at least a portion thereof being asymmetric can be shaped differently from each other and rotated together in a coordinated fashion to provide continuously widening and narrowing gaps between the flutes of the screws. This tends to minimize or eliminate the clumping, bridging and clogging found in other fluted conveyances, while still providing the desired functions of mixing and conveying the input materials.

Although various embodiments disclosed herein discuss mixing and conveying specific foodstuff materials for purposes of illustration, it will be readily appreciated that the disclosed features, apparatuses, systems, and methods can similarly be used for any relevant processing of other foodstuff materials and/or any other pertinent materials. For example, the disclosed foodstuff material processing device can also be used with soy lecithin as an alternative to methylcellulose. In some situations, the disclosed foodstuff material processing device can also be used to mix and convey or otherwise process materials that are not foodstuff based, such that it can simply be called a material processing device. Other applications, arrangements, and extrapolations beyond the illustrated embodiments are also contemplated.

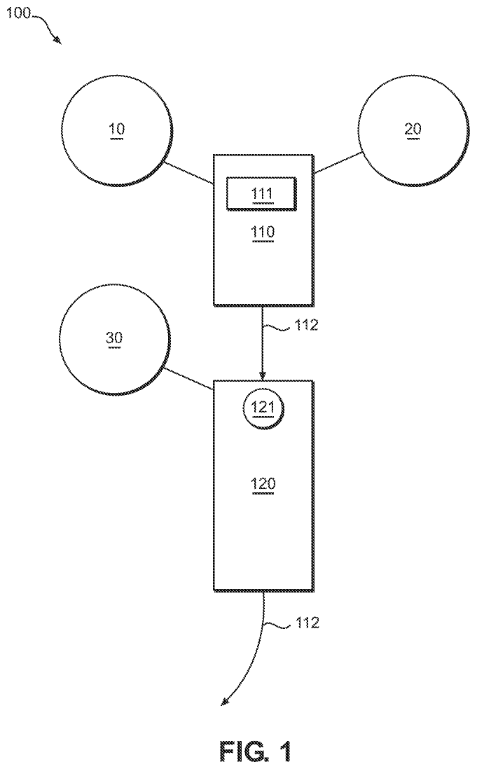

Referring first to FIG. 1, an example foodstuff material processing device is shown in block diagram format. Foodstuff material processing device 100 can include, for example, an upstream portion 110 and a downstream portion 120, both of which can be housed separately or together within the same housing, as noted below. Upstream portion 110 of foodstuff material processing device 100 can have a solid foodstuff inlet 111 that can be used to provide foodstuff materials into the upstream portion 110 and an output or transition 112 to downstream portion 120. In various arrangements, solid foodstuff inlet 111 can be used to provide solid foodstuff materials into the device. For example, a first solid foodstuff material 10 can be provided into the device at a first inlet region of solid foodstuff inlet 111, while a separate second solid foodstuff material 20 can be provided into the device at a second inlet regions of solid foodstuff inlet 111. These can be at different regions of the same housing opening. Alternatively, separate openings in the housing can be used.

Downstream portion 120 can receive the output 112 of partially mixed and conveyed solid foodstuff materials from upstream portion 110, whereupon a liquid foodstuff material 30 can then be added to the mixture by way of a liquid foodstuff inlet 121. This can also be considered a third inlet region for purposes of discussion. One or more other solid and/or liquid inlets may also be used as may be desired for given mixtures and designs. The first solid foodstuff material 10, second solid foodstuff material 20, and liquid foodstuff material 30 can then be mixed while being conveyed through downstream portion 120 until they arrive at an outlet 122 of the foodstuff material processing device 100.

Various different foodstuff materials can be used for this mixing and conveying process. In particular, it is contemplated that the solid foodstuff materials be in small pieces, flakes, or even powders. For example, first solid foodstuff material 10 can be hydrated vegetable protein, while second solid foodstuff material 20 can be a soy protein and methylcellulose mixture. Liquid foodstuff material 30 can be an oil and water mixture, for example. Of course, other foodstuffs may also be used, and the examples of soy protein, hydrated vegetable protein, methylcellulose, oil, and water, are provided here simply for purposes of illustration.

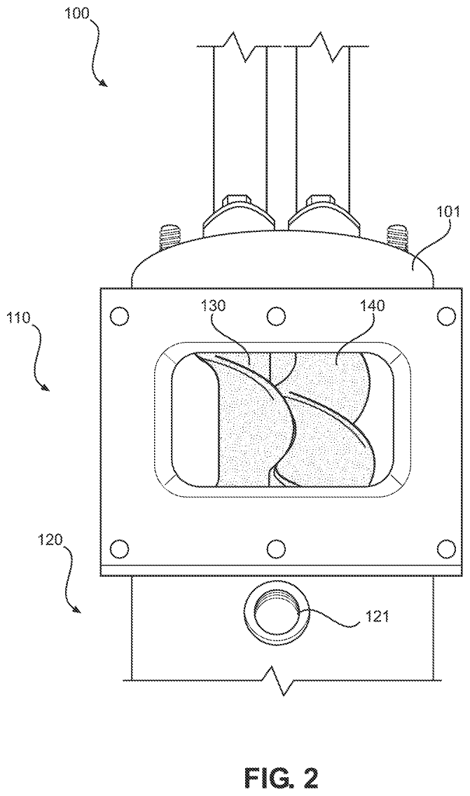

Turning next to FIG. 2, an upstream portion of an example foodstuff material processing device having processing shafts with at least a portion thereof being asymmetric is illustrated in top plan view. Again, foodstuff material processing device 100 can include a fully depicted upstream portion 110 and a downstream portion 120 that is only partially shown for purposes of illustration. An outer housing 101 can contain both upstream portion 110 and downstream portion 120 within a single housing, although other arrangements with multiple housing or sections are also possible. Again, upstream portion 110 can have a solid foodstuff inlet 111 configured for solid foodstuff materials and downstream portion 120 can have a liquid foodstuff inlet 121 (i.e., the third inlet region) configured for liquid foodstuff materials.

Foodstuff material processing device 100 can also have a first processing shaft 130 and a second processing shaft 140, which can be arranged proximate to and parallel with each other. Both of the first and second processing shafts 130, 140, which can also be called fluted or threaded augers or any other appropriate term for a screw conveyor, can extend longitudinally through the outer housing 101 from at least solid foodstuff inlet 111 all the way to the outlet (not shown) of the foodstuff material processing device 100. Both of the first and second processing shafts 130, 140 can also be configured to rotate with the outer housing 101 to convey the solid and liquid foodstuff materials from the solid foodstuff inlet 111 and liquid foodstuff inlet 121 to the outlet of the foodstuff material processing device 100. First processing shaft 130 and second processing shaft 140 can also be configured to operate in conjunction with each other to mix the solid and liquid foodstuff materials during conveyance from the inlets to the outlet.

As shown, solid foodstuff inlet 111 can be oriented such that it is perpendicular to the axes of rotation of the first and second processing shafts 130, 140. As such, solid foodstuff materials can be deposited directly onto the flutes of the first and second processing shafts 130, 140 through the solid foodstuff inlet 111. The material flow then changes direction from passing through the solid foodstuff inlet 111 to being conveyed along the first and second processing shafts 130, 140 toward the liquid foodstuff inlet 121. Again, solid foodstuff inlet 111 can have different inlet regions, such as a first inlet region above first processing shaft 130 and a second inlet region above second processing shaft 140. This can allow for the introduction of one solid foodstuff material at the first inlet region onto first processing shaft 130 and a different solid foodstuff material at the second inlet region onto second processing shaft 140, for example.

Liquid foodstuff inlet 121 can also be oriented such that it is perpendicular to the axes of rotation of the first and second processing shafts 130, 140. Similarly, liquid foodstuff materials can be deposited directly onto the flutes of the first and second processing shafts 130, 140 through the liquid foodstuff inlet 121. The material flow then continues in the same direction past liquid foodstuff inlet 121 to the outlet of the foodstuff material processing device 100, as will be readily appreciated for typical screw conveyor type process flows.

In some arrangements, first and second processing shafts 130, 140 can substantially fill all or most of the internal space within outer housing 101, such that foodstuff materials can be conveyed, mixed, and otherwise processed with minimal dead zones or other inefficient regions within the outer housing 101. As shown, the flutes of first and second processing shafts 130, 140 can overlap or “mate” with each other, such that materials conveyance and mixing can be more efficient. In addition, first and second processing shafts 130, 140 can both have different portions or regions along the lengths of the processing shafts, with the different portions having varying functionalities and efficiencies. Only one portion of each processing shaft 130, 140 can be seen directly through solid foodstuff inlet 111 as shown in FIG. 2 though, such that an internal view is more illustrative.

Continuing with FIG. 3 the foodstuff material processing device of FIG. 2 is shown in top plan view with its outer housing removed. Again, foodstuff material processing device 100 can include a first processing shaft 130 and a second processing shaft 140. First processing shaft 130 can have one or more flutes 134 (i.e., threads) along its length, and second processing shaft 140 can similarly have one or more flutes 144 along its length. These flutes 134, 144 extend from a screw core and serve to convey materials therealong as each processing shaft rotates, as will be readily appreciated. Due to the overlapping or mating nature of the flutes in the first and second processing shafts 130, 140, mixing of the materials can also take place as the materials are being conveyed.

First processing shaft 130 can have a first fluted infeed portion 131 at an upstream portion of the foodstuff material processing device 100 and a first mixing portion 132 at a downstream portion of the foodstuff material processing device 100. Similarly, second processing shaft 140 can have a second fluted infeed portion 141 at an upstream portion of the foodstuff material processing device 100 and a second mixing portion 142 at a downstream portion of the foodstuff material processing device 100. In some arrangements, first processing shaft 130 can have a first final conveyance portion 133 and second processing shaft 140 can have a second final conveyance portion 143, with these final conveyance portions being located just before the outlet of the foodstuff material processing device 100.

As may be readily appreciated, first fluted infeed portion 131 and second fluted infeed portion 141 are the only fluted infeed portions that are visible through solid foodstuff inlet 111 as shown in FIG. 2, since first and second fluted infeed portions 131, 141 are proximate solid foodstuff inlet 111. Conversely, first mixing portion 132 and second mixing portion 142 extend from about the liquid foodstuff inlet 121 to the outlet of the foodstuff material processing device 100 and cannot be seen through solid foodstuff inlet 111. First fluted infeed portion 131 and second fluted infeed portion 141 can operate in conjunction with each other to convey materials and possibly introduce the materials to each other through the upstream portion of the foodstuff material processing device 100, while first mixing portion 132 and second mixing portion 142 can operate in conjunction with each other convey and mix materials through the downstream portion of the foodstuff material processing device 100.

In the embodiment illustrated, first mixing portion 132 and second mixing portion 142 are simple threaded rotational mixing and conveying shaft portions. It will be appreciated that such mixing arrangements are not limited to simple threads. In various alternative arrangements, first and second mixing portions 132, 142 can have flutes, lobes, blades, fins, or other forms of rotations mixing protrusions.

In various embodiments, first mixing portion 132 and second mixing portion 142 in the downstream portion of the device can be symmetrical and have symmetrical flutes or threads. Such symmetry works well in mixing materials together as they are conveyed along this downstream portion of the processing shafts 130, 140. However, such symmetry can be problematic with respect to causing clumping, bridging, and clogging of disparate materials soon after the disparate materials have been input into the system and are not yet somewhat mixed.

Accordingly, first fluted infeed portion 131 and second fluted infeed portion 141 in the upstream portion of the device can be asymmetrical and have asymmetrical flutes. Such asymmetry does not mix materials as well as symmetrical flutes do, but this asymmetry substantially reduces or eliminates clumping, bridging, and clogging of materials, as well as the premature introduction of materials, just after the materials are input and are not yet adequately mixed together as they are being conveyed and mixed. This can be due to the continuous widening and narrowing gaps between the asymmetric flutes as the processing shafts 130, 140 are rotated, which fluctuating gaps minimize material clumping between the rotating flutes.

Various forms of asymmetry can be applied to first fluted infeed portion 131 and second fluted infeed portion 141 to accomplish this effect. For example, first fluted infeed portion 131 can be single fluted while second fluted infeed portion 141 can be double fluted in some arrangements. That is, a single flute or thread can extend from the core of first processing shaft 130 along the length of first fluted infeed portion 131, while two flutes or threads can extend opposite each other from the core of second processing shaft 140 along the length of second fluted infeed portion 141. The pitch of both of first and second processing shafts 130, 140 can be the same in such arrangements. In a specific non-limiting example, the length of both of first and second processing shafts 130, 140 can be about four inches and each flute can make one rotation around its respective infeed screw along that length, resulting in a pitch of about one revolution per four inches. Of course, other dimensions and pitches are also possible.

Other forms of asymmetry may be applied alternatively or in addition to the foregoing. For example, asymmetrical processing shafts may have different pitches, and/or more than one or two flutes per processing shaft may be used. Furthermore, the asymmetrical portions of the processing shafts may be longer or may extend for the entire length of the processing shaft in some arrangements. Other variations are also possible to result in the desired effect of fluctuating gap sizes between the rotating mating flutes to reduce or eliminate material clumping, as will be readily appreciated.

In various embodiments, both of first and second processing shafts 130, 140 can be integrally formed from a single material. In other arrangements, the different fluted infeed portions can be separately formed and fastened together and can be formed from the same or different materials. For example, first fluted infeed portion 131 and second fluted infeed portion 141 can be custom formed by three-dimensionally printing these portions with a resin material or can be formed by die casting each portion with a suitable metal, plastic, resin, or other material. First mixing portion 132 and second mixing portion 142 can be standard symmetrical mating processing shafts that are then aligned with and fastened to first fluted infeed portion 131 and second fluted infeed portion 141 respectively. Other formation approaches and materials are also possible.

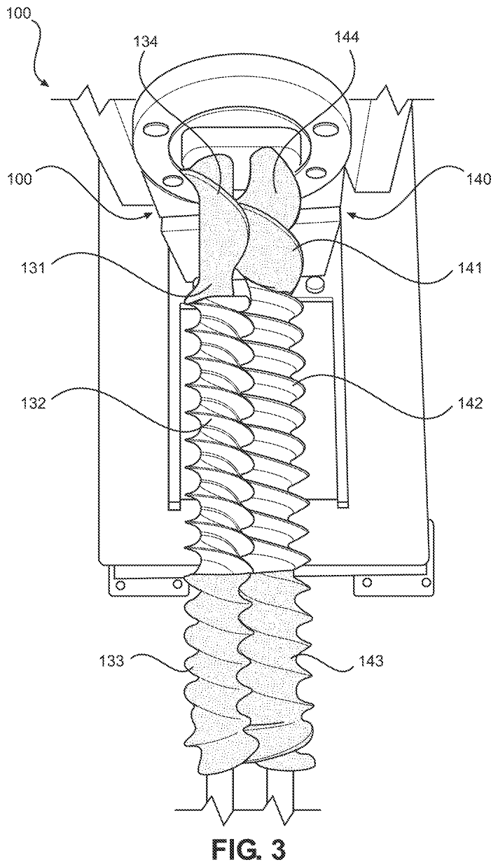

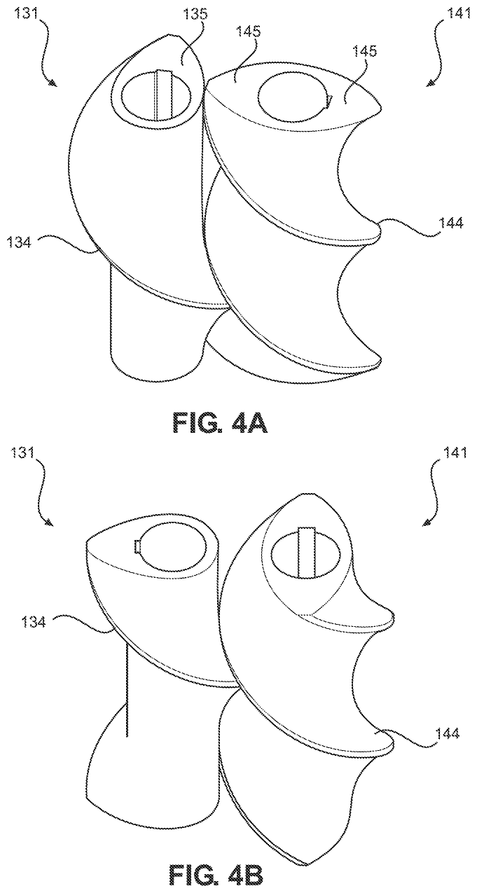

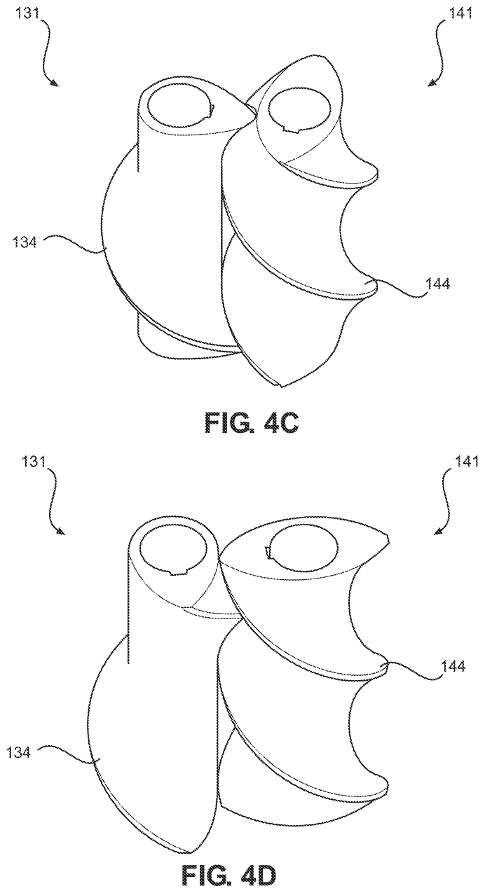

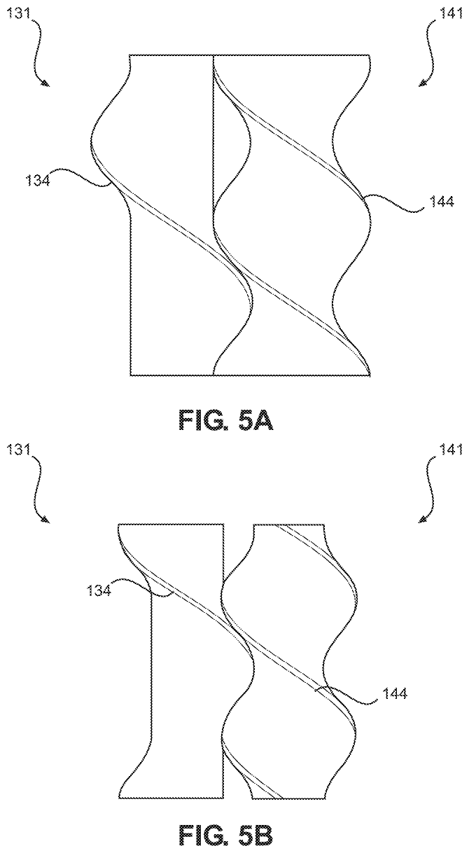

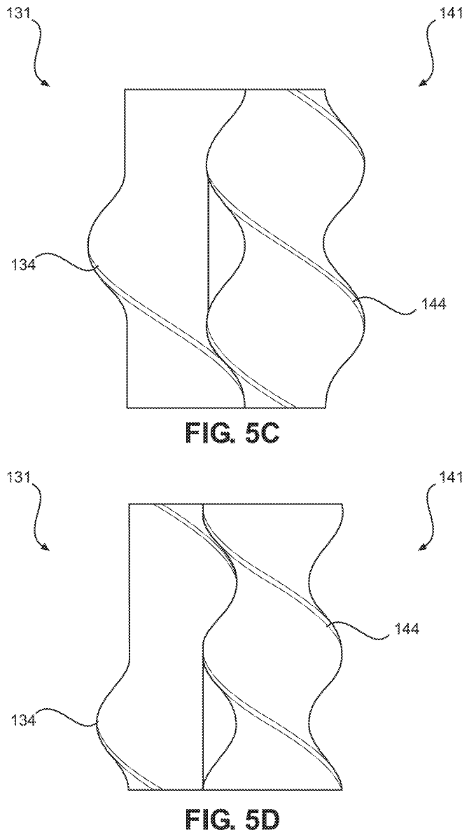

FIGS. 4A-4D illustrate in side perspective view asymmetric fluted infeed portions at various stages of rotation. Similarly, FIGS. 5A-5D illustrate in top plan view the same asymmetric fluted infeed portions at various stages of rotation. For purposes of simplicity in illustration, only first fluted infeed portion 131 and second fluted infeed portion 141 are shown in these series of figures to emphasize the nature of the asymmetry between these fluted infeed portions in rotational operation. Again, first fluted infeed portion 131 can be single fluted while second fluted infeed portion 141 can be double fluted. That is, a single flute 134 extends from the core of first fluted infeed portion 131, while double flutes 144 extend from the core of second fluted infeed portion 141.

This single and double fluted arrangements can be readily observed at the distal endpoint of each fluted infeed portion. For first fluted infeed portion 131, only a single distal flute end 135 extends from the fluted infeed portion core, while for second fluted infeed portion 141, two (i.e., double) distal flute ends 145 extend from the fluted infeed portion core.

FIG. 4A can show initial relative rotational positions of first and second fluted infeed portions 131, 141. FIG. 4B shows relative rotational positions after a partial rotation of each fluted infeed portion, and FIGS. 4C and 4D show relative rotational positions after a further partial rotation and still further partial rotation of each fluted infeed portion. Similarly, FIG. 5A can show the same or similar initial relative rotations positions of first and second fluted infeed portions 131, 141, while FIGS. 5B-5D each show relative rotational positions after increasing partial rotations.

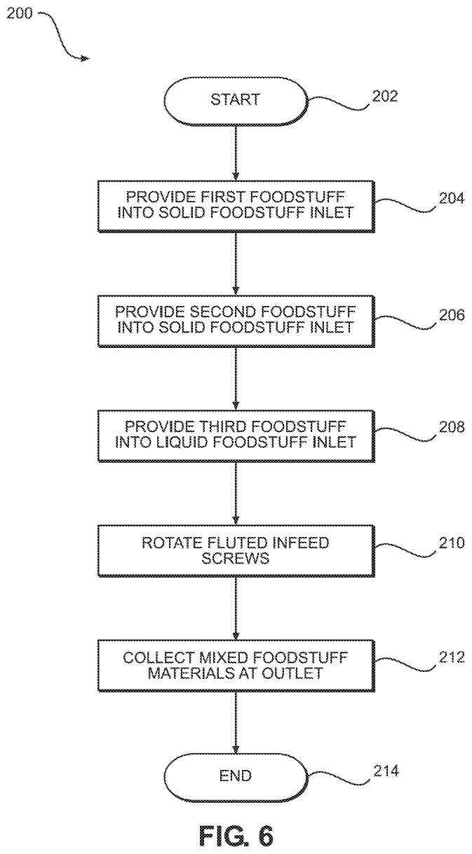

Finally, FIG. 6 provides a flowchart of an example method 200 of mixing foodstuffs using processing shafts with at least a portion thereof being asymmetric. The asymmetric processing shafts can be part of a foodstuff material processing device, such as that which is set forth above in FIGS. 1 through 5D and the accompanying description. After a start step 202, a first process step 204 can involve providing a first foodstuff material into a solid foodstuff inlet. This can be at a first inlet region of the solid foodstuff inlet. The first foodstuff material can be a solid foodstuff material, such as, for example, a hydrated vegetable protein. Other solid foodstuff materials can be added or can alternatively be used at this step.

At the next process step 206, a second foodstuff material can be provided into the solid foodstuff inlet. This can be at a second inlet region of the solid foodstuff inlet. The second foodstuff material can be a different solid foodstuff material, such as, for example, a soy protein. Other solid foodstuff materials can be added or can alternatively be used at this step. For example, a methylcellulose and seasoning powder mix can be provided with the soy protein. The second foodstuff material can be provided at a different location at the solid foodstuff inlet than the first foodstuff material. For example, the first foodstuff material can be deposited onto the flutes of a first processing shaft located at the solid foodstuff inlet while the second foodstuff material can be deposited onto the flutes of an adjacent parallel second processing shaft also located at the solid foodstuff inlet.

At the following process step 208, a third foodstuff material can be provided into a liquid foodstuff inlet. This can be considered a third inlet region. The third foodstuff material can be a liquid foodstuff, such as, for example, an oil and water mixture. Other liquid foodstuff materials can be added or can alternatively be used at this step. The third foodstuff material can be deposited onto the flutes of one or both of the first and second processing shafts. Also, the liquid foodstuff inlet can be located downstream of the solid foodstuff inlet on the foodstuff material processing device.

At subsequent process step 210, the processing shafts can be rotated. This can result in the first, second, and third foodstuffs being mixed together as they are all being conveyed from the respective inlets to an outlet of the foodstuff material processing device. As noted above, this mixing and conveying can occur without any significant clumping, bridging, or clogging of the materials due to the asymmetric nature of the processing shafts.

At the next process step 212, the mixed and conveyed foodstuff materials can be collected at an outlet of the foodstuff material processing device. If desired, the method can then be repeated to mix and convey additional foodstuff materials. Alternatively, the method then ends at end step 214.

It will be appreciated that the foregoing method may include additional steps not shown, and that not all steps are necessary in some embodiments. For example, additional steps may include premixing one or more of the foodstuff materials. Other steps may include part replacement or maintenance of the foodstuff material processing device. Furthermore, the order of steps may be altered as desired, and one or more steps may be performed simultaneously. For example, some continuous processes may result in all of steps 204-212 being performed simultaneously during typical production.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. An apparatus configured to process foodstuff materials, the apparatus comprising:
an outer housing having at least a first inlet region, a second inlet region, a third inlet region, and an outlet, wherein the first inlet region and the second inlet region are configured to accept one or more solid foodstuff materials and the third inlet region is configured to accept one or more liquid foodstuff materials downstream from the first and second inlet regions;
a first processing shaft extending through the outer housing from the first inlet region to the outlet, the first processing shaft having a first fluted infeed portion proximate the first inlet region and a first mixing portion extending from the third inlet region to the outlet, wherein the first processing shaft is configured to rotate within the outer housing to convey the solid and liquid foodstuff materials from the first, second, and third inlets to the outlet; and
a second processing shaft extending through the outer housing from the second inlet region to the outlet, the second processing shaft being situated proximate and parallel to the first processing shaft and having a second fluted infeed portion proximate the second inlet region and a second mixing portion extending from the third inlet region to the outlet, wherein the second processing shaft is configured to rotate within the outer housing to convey the solid and liquid foodstuff materials from the first, second, and third inlets to the outlet and to operate in conjunction with the first processing shaft to mix the solid and liquid foodstuff materials during conveyance thereof, and wherein at least a portion of the first and second processing shafts are asymmetric with respect to each other.

2. The apparatus of claim 1, wherein the first fluted infeed portion is asymmetric with respect to the second fluted infeed portion.

3. The apparatus of claim 2, wherein the first fluted infeed portion is single fluted and the second fluted infeed portion is double fluted.

4. The apparatus of claim 3, wherein the pitch of the first fluted infeed portion is the same as the pitch of the second fluted infeed portion.

5. The apparatus of claim 4, wherein the pitch of both the first fluted infeed portion and the second fluted infeed portion is about one revolution per four inches.

6. The apparatus of claim 2, wherein the first mixing portion is symmetric with respect to the second mixing portion.

7. The apparatus of claim 1, wherein the first inlet region is oriented perpendicular to the axes of rotation of the first and second processing shafts.

8. The apparatus of claim 7, wherein the first inlet region is configured to deposit at least one of the one or more solid foodstuff materials directly onto the flute of the first fluted infeed portion.

9. The apparatus of claim 1, wherein the second inlet region is oriented perpendicular to the axes of rotation of the first and second processing shafts.

10. The apparatus of claim 9, wherein the second inlet region is configured to deposit at least one the one or more liquid foodstuff materials directly onto the flute of the second fluted infeed portion.

11. The apparatus of claim 1, wherein the lengths of the first fluted infeed portion and the second fluted infeed portion are about four inches each.

12. A conveyance, comprising:
a first processing shaft having a first fluted infeed portion and a first mixing portion, wherein the first processing shaft is configured to rotate to convey materials along the first fluted infeed portion and the first mixing portion; and
a second processing shaft situated proximate and parallel to the first processing shaft and having a second fluted infeed portion proximate the first fluted infeed portion and a second mixing portion proximate the second mixing portion, wherein the second processing shaft is configured to rotate to convey materials along the second fluted infeed portion and the second mixing portion; and to operate in conjunction with the first processing shaft to mix the materials during conveyance thereof, and wherein at least a portion of the first and second processing shafts are asymmetric with respect to each other.

13. The conveyance of claim 12, wherein the first fluted infeed portion is asymmetric with respect to the second fluted infeed portion.

14. The conveyance of claim 12, wherein the first fluted infeed portion is single fluted and the second fluted infeed portion is double fluted.

15. The conveyance of claim 14, wherein the pitch of the first fluted infeed portion is the same as the pitch of the second fluted infeed portion.

16. The conveyance of claim 15, wherein the pitch of the first fluted infeed portion and the second fluted infeed portion is about one revolution per four inches.

17. The conveyance of claim 12, wherein the first mixing portion is symmetric with respect to the second mixing portion.

18. A method of mixing foodstuff materials, the method comprising:
providing a first foodstuff material into a first inlet region of a foodstuff material processing device, the foodstuff material processing device having a first processing shaft having a first fluted infeed portion and a first mixing portion and a second processing shaft situated proximate and parallel to the first processing shaft and having a second fluted infeed portion proximate the first fluted infeed portion and a second mixing portion proximate the second mixing portion, wherein at least a portion of the first and second fluted infeed portions are asymmetric with respect to each other;
inputting a second foodstuff material into the second inlet region of the foodstuff material processing device;
introducing a third foodstuff material into a third inlet region of the foodstuff material processing device, the third inlet region being located downstream from the first inlet region and the second inlet region;
rotating the first and second processing shafts to mix and convey the first, second, and third foodstuff materials from the first, second, and third inlets to an outlet of the foodstuff material processing device; and
collecting a resulting mixed foodstuff material at the outlet.

19. The method of claim 18, wherein the first processing shaft is configured to rotate to convey the first, second, and third foodstuff materials along its first fluted infeed portion and first mixing portion, and wherein the second processing shaft is configured to rotate to convey the first, second, and third foodstuff materials along its second fluted infeed portion and second mixing portion, and to operate in conjunction with the first processing shaft to mix the first, second, and third foodstuff materials during conveyance thereof.

20. The method of claim 18, wherein the first and second foodstuff materials are solid and the third foodstuff material is liquid.
